(19) United States
(12) Patent Application Publication
(10) Pub. No.: US 2024/0183532 A1
(43) Pub. Date: Jun. 6, 2024

(54) REGENERATIVE BURNER SYSTEM

(71) Applicant: SISTEM TEKNIK ENDÜSTRIYEL FIRINLAR LIMITED SIRKETI, Çayirova, Kocaeli (TR)

(72) Inventor: Kadir KÖSOGLU, Çayirova, Kocaeli (TR)

(21) Appl. No.: 18/554,760

(22) PCT Filed: Sep. 28, 2022
(86) PCT No.: PCT/TR2022/051054

§ 371 Date: Oct. 10, 2023

(30) Foreign Application Priority Data
Oct. 4, 2021 (TR) 2021/015453

(51) Int. Cl. F23L 15/02; F27B 3/26

(52) U.S. Cl. CPC F23L 15/02; F27B 3/263

(57) ABSTRACT

Disclosed is a regenerative burner system for use in industrial furnaces, containing at least one burner which generates heat by forming a flame by combining air with a gas contained therein to maximize the use of the heat emitted from the chimney of the furnace; and a regenerator over which a fluid flows, which first stores the heat generated by the burner on a filler with a high heat capacity and then transfers this heat to the fluid, which contains a grate piece which is in an inclined position in the regenerator, has filler on it and passes air flow through the filler, at least one discharge door transferring the end-of-life filler to the basket located outside the regenerator, and at least one filling door transferring the new filler to the chamber located in the regenerator.

### TECHNICAL FIELD

The invention relates to a regenerative burner system.

The invention relates to a regenerative burner system used in industrial furnaces, consisting of a regenerator which first stores the heat on the filler and then transfers this heat to the fluid flowing through it, and a burner which heats the furnaces, and which is developed to utilize the heat discharged from the chimney to the maximum extent.

### PRIOR ART

Nowadays, a regenerative burner is known as a combustion heating system that allows efficient recovery of exhaust heat in an industrial furnace. Burners are used to generate heat for heating industrial furnaces. Burners can reach temperatures between approximately 0-1300° C. With regenerative burners, it can reach 1000° C. combustion air temperature with an efficiency of up to 90% at 1500° C. operating temperature. In this way, it provides energy savings of up to 50%. Energy efficiency in industrial furnaces is largely directly related to combustion efficiency. One of the main parameters affecting combustion efficiency is burner selection and positioning. These burners are designed to recover and reuse the exhaust heat from the high-temperature combustion chamber and to heat the combustion air. While the flue gases, which are hot due to the process in furnaces, are discharged into the atmosphere, a significant amount of energy is also discharged. Regenerative burners are used to recover a certain part of this energy and to maximize the use of the heat discharged from the chimney.

In the present art, the most effective way to improve the efficiency of the combustion system is to preheat the combustion air. The preheating of the combustion air takes place in the regenerator. Thanks to the fillers with high heat capacity in the regenerator, heat is first stored on these materials and then transferred to the fluid flowing over them.

In another existing technique, regenerators are generally of two types, chamber and opening door, depending on the method of replacement of the fillers. In the chamber exchange type, the chamber containing the fillers is replaced with a spare one for the replacement of the fillers. In this system, the chamber and the upper half of the regenerator are mounted with bolts that rotate around its shaft. In this type of regenerators, the replacement of the filler causes a loss of time and an increase in cost due to the use of spare reservoirs. In the other type, the model with opening door, the fillers are transferred to the basket from the slot in the upper half of the regenerator for the replacement of the fillers. While the expired fillers are transferred to the basket, new fillers are transferred to the chamber through the slot at the top of the box. Thus, only the filler is changed. However, in this process, it takes a certain period of time for the temperature of the fillers with high temperatures to decrease and for the new fillers to store heat after they are transferred to the basket. This causes a loss of time.

As a result of the research on the subject, application number RU0002581683 was found. The application discloses an inverted regenerative burner and furnace heating method. The application relates to a single-stage heat regenerator provided with a burner casing having a gas passage and a casing enclosing a fluid porous heat regenerative medium bed. A first gas passageway in the housing directly connects the gas duct and the bottom surface of the media bed. A second gas passageway in the casing connects an opening in the casing in communication with the outer and upper surface of the media bed. This arrangement allows the hot waste combustion gases to pass upwards through the media bed, so that any condensable contaminants in the gases condense into a liquid and flow out of the bed under gravity, before becoming solid and clogging the bed. However, there is no mention of a regenerative combustion system developed to maximize the use of the heat discharged from the chimney, consisting of a regenerator that first stores the heat in the filler and then transfers it to the fluid flowing through it, and a burner that heats the furnaces. The application does not include structures with high thermal capacity that store heat and then transfer it to the fluid flowing over it.

As a result of a search on the subject, application number TR2011/11198 was found. The application relates to a method of heating molten glass by a furnace comprising lateral walls equipped with transverse burners and equipped with regenerators, wherein at least one burner is fed with caustic material and combustible material containing at least 30% oxygen by volume, such that the ratio of combustible impulse to caustic impulse is 5-13. However, the application does not include structures with high heat capacity that store heat and then transfer this heat to the fluid flowing over it.

As a result, due to the above-mentioned negativities and the inadequacy of the existing solutions on the subject, it has become necessary to make an improvement in the relevant technical field.

### PURPOSE OF THE INVENTION

The invention is inspired by existing situations and aims to solve the above-mentioned problems.

The main purpose of the invention is to provide convenience to the user and to reduce time losses during the replacement of fillers with high heat capacity in a regenerative burner system used in industrial furnaces, which store heat on itself and then transfer this heat to the fluid flowing over it.

In order to fulfill the above-mentioned purposes, characterized by comprising a regenerative burner system used in industrial furnaces to ensure maximum use of the temperature coming out of the chimney of the furnace containing at least one burner that provides heat by creating a flame by combining flammable organic gases such as methane or propane with air,
a regenerator through which air or air waste gas mixture passes, which first stores the heat generated by the burner on a filler inside and then transfers this heat to the air or air waste gas mixture,
at least one grate part that is inclined in the regenerator and has a filler on it and passes the air or air waste gas mixture through the filler,
at least one discharge door that transfers the end-of-life filler to a basket located outside the regenerator and
at least one filling door that transfers the new filler to the chamber in the regenerator

The structural and characteristic features and all advantages of the invention will be more clearly understood by means of the figures given below and the detailed description written by making references to these figures, and therefore, the evaluation should be made by considering these figures and detailed description.

### FIGURES TO HELP UNDERSTANDING OF THE INVENTION

FIG. 1 is a general view of the regenerative burner system, which is the subject of the invention.

FIG. 2 is a cross-sectional view of the regenerative burner system, which is the subject of the invention.

FIG. 3 is a cross-sectional view of the regenerator contained in the regenerative burner system, which is the subject of the invention.

FIG. 4 is a top view of the grate part of the regenerative burner system, which is the subject of the invention.

FIG. 5 is a detail view of the bolts assembled by rotating around the shaft of the regenerative burner system, which is the subject of the invention.

FIG. 6 is a view of the regenerative burner system, which is the subject of the invention with the basket.

FIG. 7 is a representative view of the regenerators with changing chamber (A) and opening door (B) used in the present art.

FIG. 8 shows the principle of operation of the regenerative burner system of the present art and the invention as first cycle (A) and second cycle (B).

### DESCRIPTION OF PART REFERENCES

1. Burner
2. Regenerator
3. Filling door
4. Discharge door
5. Grate piece
6. Connection part
7. Filler
8. Shaft
9. Basket
A. First Cycle
B. Second Cycle

### DETAILED DESCRIPTION OF THE INVENTION

In this detailed description, the preferred embodiments of the inventive regenerative burner system are described only for a better understanding of the subject matter.

The invention is a regenerative burner system, especially used in industrial furnaces, consisting of a regenerator (2) which first stores the heat on the filler (7) and then transfers this heat to the fluid flowing over it, and a burner (1) which heats the furnaces, and is developed to maximize the use of the heat discharged from the chimney.

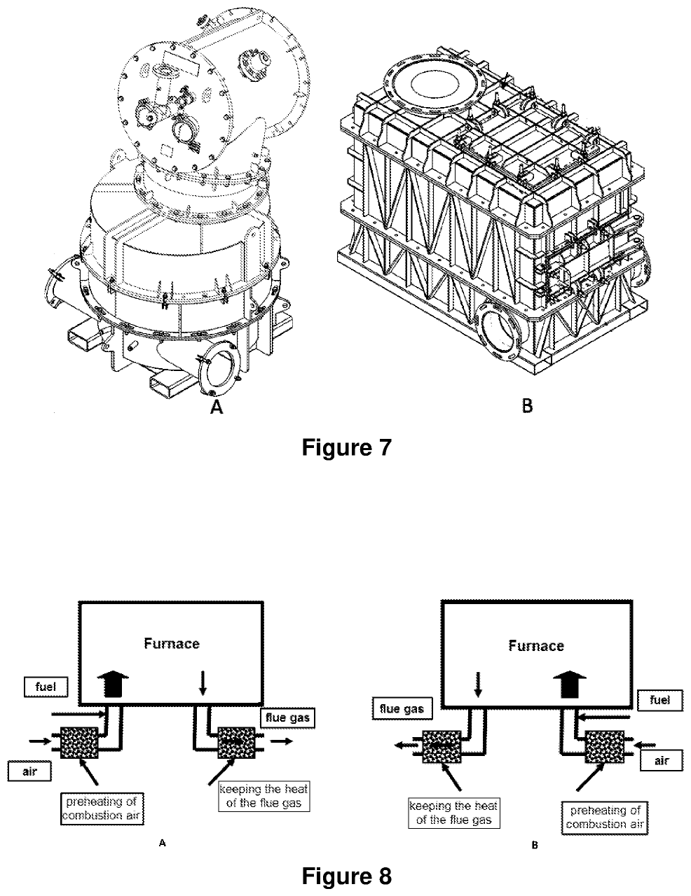

FIG. 7 shows a representative view of the alternating chamber and opening door regenerators used in the present art. FIG. 8 shows schematically the working principle of the regenerative burner system as first cycle (A) and second cycle (B) in the present art. In the inventive burner system, the operating principle is common with the present art. In the first cycle, while one burner is operating in the normal position, the other burner collects the burner gases and stores their heat in the regenerator. In the second cycle, this heat is used to heat the burner air and this time the other burner collects the combustion gases and stores the heat. As a result, the two burners perform the combustion and heat collection tasks respectively.

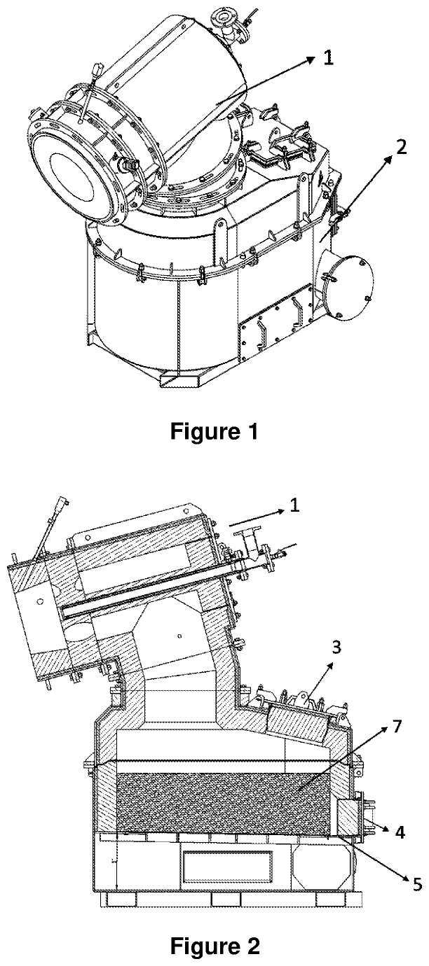

FIG. 1 shows the general view of the inventive regenerative burner system. Accordingly, the inventive regenerative burner system consists of a burner (1) and a regenerator (2). The regenerator (2) first stores the heat on the filler (7) and then transfers this heat to the fluid flowing over it. The regenerators, which are the most important part of the invention, work like a heat exchanger, collecting the heat of the flue gases and heating the combustion air. Thanks to the regenerators, the high-temperature heat carried by the combustion gases in the first cycle is passed through the regenerators before being released to the atmosphere, and the heat carried by the regenerators is used to heat the combustion air to be used in the second cycle and thus to realize the combustion event with less energy. Regenerative burners (1) are based on the principle of mutual and controlled operation of two heat cell structures with the same characteristics. The way it works is that the waste heat carried by the flue gas is used instead of combustion air. In order for the system to work successfully, it must be supported by automation systems and continuously controlled. The porous elements in the regenerator where the heat is stored are called filler (7). Ceramic or alumina balls with high heat capacity are used as fillers (7). These fillers (7) are replaced at certain intervals after the end of their life. The invention has been developed to provide convenience to the user and to reduce time losses in the replacement of the fillers (7).

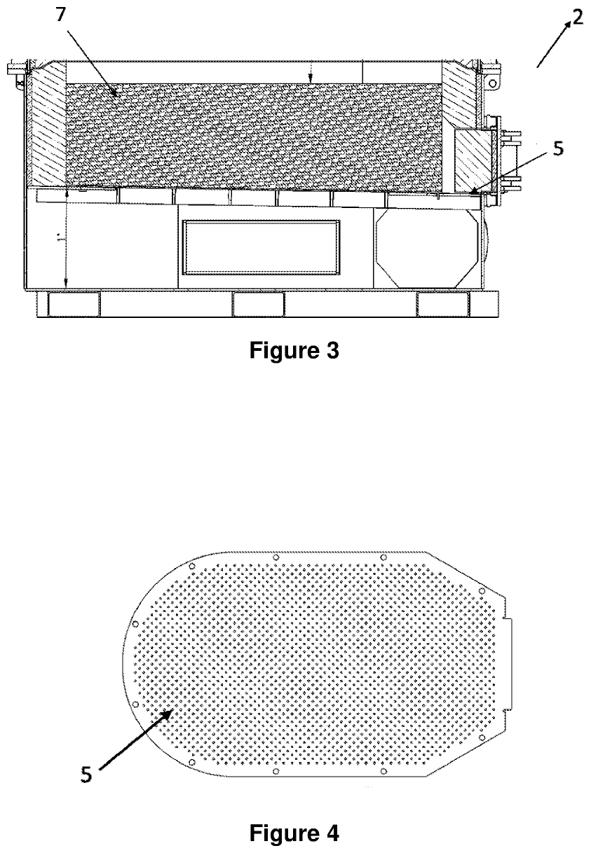

The aim of the invention, whose cross-sectional views are shown in FIGS. 2 and 3, is to reduce the time and energy losses during the replacement of the fillers (7) used in the regenerator (2) after the end of their life. With the developed invention, the fillers are located in the regenerator (2) on the grate piece (5) made of stainless steel, preferably with a wall thickness of 5 mm, whose hole number and size are determined by the analysis studies. Thanks to the grate piece (5), whose top view is shown in FIG. 4, the air flow can pass through the fillers (7) and release its heat to these materials. Furthermore, the grate piece (5) is preferably positioned at an inclination of 1° to the bottom, so that the fillers (7) can be easily transferred out during discharge.

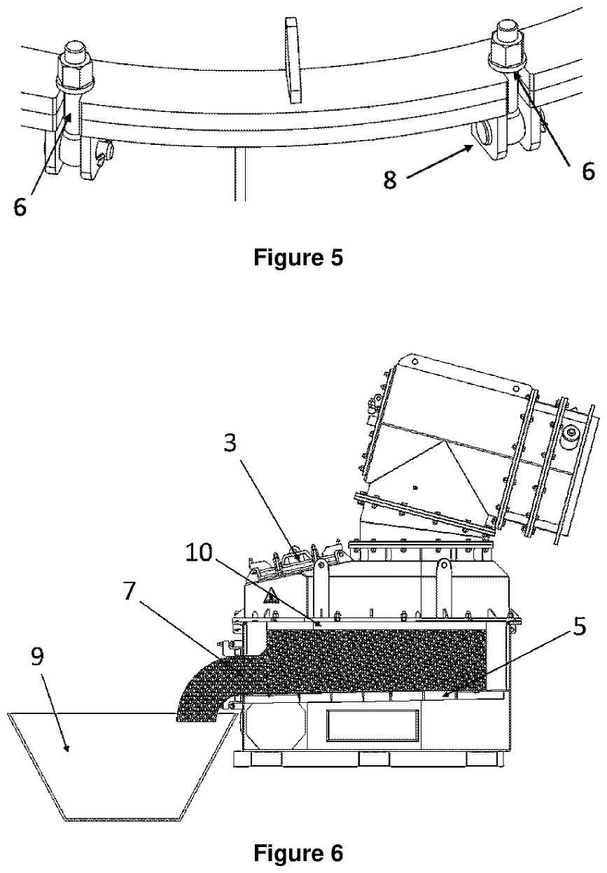

For the replacement of the filler (7) in the regenerator (2), the features of the two existing types, the one with the changing chamber and the one with the opening door, were combined in a single regenerator (2). The chamber (10) and the upper half of the regenerator are mounted with bolts (6) that rotate around the shaft (8). FIG. 5 shows a detail view of the bolts (6) rotating around the shaft (8) in the regenerative burner system. After the fillers (7) reach the end of their life, the chamber (10) mounted by means of bolts (6) can be replaced with a spare chamber (10) containing new fillers (7) according to the user's preference. FIG. 6 shows a view of the chamber (10) and the basket (9) in which the fillers (7) are transferred.

In an alternative embodiment of the invention, the fillers (7) can be transferred to the basket (9) through a discharge door (4) opened in the sheet metal of the regenerator (2) for replacement. New fillers are discharged into the regenerator (2) through the filling door (3). Thus, the end user is offered an alternative for changing the fillers (7).

The high-temperature flue gas passes through the fillers (7) with high heat capacity located on the grate piece (5) in the regenerator (2) and reaches the burner (1). The heat stored by the fillers (7) heats the air passing through them in the next cycle.

1. A regenerative burner system used in industrial furnaces, which contains at least one burner that provides heat by forming a flame by combining flammable organic gases such as methane or propane with air in order to maximize the use of the temperature coming out of the chimney of the furnace, the system, comprising:
a regenerator that passes through air or air waste gas mixture, first stores the heat generated by the burner on a filler inside the burner and then transfers this heat to the air or air waste gas mixture;
at least one grate piece which is inclined in the regenerator and has a filler on the grate piece, passing air or air waste gas mixture through the filled;
at least one discharge door that transfers the end-of-life filler to a basket located outside the regenerator; and
at least one filling door that transfers the new filler to the chamber in the regenerator.

2. The regenerative burner system according to claim 1, comprising an alumina ball or honeycomb or similar fillers having a heat capacity of 0.3 Cal/g° C. @700°.

3. The regenerative burner system according to claim 1, comprising silicon dioxide, corundum mineral, cordierite porcelain, mullite-like fillers.
